(19) United States
(12) Patent Application Publication
(10) Pub. No.: US 2007/0174274 A1
(43) Pub. Date: Jul. 26, 2007

(54) Method and apparatus for searching similar music

(75) Inventors: Hyoung Gook Kim, Yongin-si (KR); Ki Wan Eom, Seoul (KR); Ji Yeun Kim, Seoul (KR); Yuan Yuan She, Beijing (CN); Xuan Zhu, Beijing (CN)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD, Suwon-si (KR)

(21) Appl. No.: 11/487,327

(22) Filed: Jul. 17, 2006

(30) Foreign Application Priority Data
Jan. 26, 2006 (KR) 10-2006-00008159

(51) Int. Cl. G06F 17/30

(52) U.S. Cl. 707/5

(57) ABSTRACT

A method of searching for similar music includes: extracting first features from music files usable to classify a music by a mood and a genre; classifying the music files according to the mood and the genre using the extracted first features; extracting second features from the music files so as to retrieve a similarity; storing both mood information and genre information on the classified music files and the extracted second features in a database; receiving an input of information on a query music; detecting a mood and a genre of the query music; measuring a similarity between the query music and the music files that are identical in mood and genre to the query music by referring to the database; and retrieving the similar music to the query music according to the measured similarity.

### CROSS-REFERENCE TO RELATED APPLICATION

This application claims priority from Korean Patent Application No. 10-2006-0008159, filed on Jan. 26, 2006, in the Korean Intellectual Property Office, the disclosure of which is incorporated herein by reference.

### BACKGROUND OF THE INVENTION

1. Field of the Invention

The present invention relates generally to a method and an apparatus for searching a similar music and, more particularly, to a method and an apparatus allowing a search for a similar music from music files which are identical in a mood and a genre to query a music requested after classifying the music files by the mood and the genre and storing a mood information and a genre information in a database.

2. Description of Related Art

A conventional method for searching for similar music extracts features from music in a decompression zone where compressed music files are decompressed, and then searches for the similar music according to the extracted features of the music. Such a method may decrease processing speed when searching the similar music.

Specifically, in order to extract features such as a timbre, a tempo, and an intensity from music files in the decompressed zone, a conventional method requires a decoding step in which compressed music files, e.g. an MP3, are converted into PCM data. Thus, the processing speed may decrease at least an amount of time required for the decoding.

Additionally, since the extraction of audio features is always performed on all music files, the searching speed may decrease.

As an example of a conventional searching method for similar music, U.S. Patent Application Publication No. 2003-0205124 discloses techniques to measure a similarity by a rhythm and a tempo between a beat spectra and to compute a similarity matrix by using MFCC features. Therefore, this method may become complex due to the similarity matrix computation and a feature extraction in a time domain. Moreover, this method measures a distance between audio features by frames and then takes a distance average of all the frames to calculate the similarity. So, if any music belonging to a different mood or a different genre has a low distance average, this method may incorrectly conclude such music to be the similar music during retrieval.

Accordingly, there is a need for an improved method to provide improve a processing speed during a search for a similar music and to prevent unfavorable errors in the search for the similar music.

### BRIEF SUMMARY

An aspect of the present invention provides a method, together with a related apparatus, which classifies music files, a target of a search, by a mood and a genre and then searches only the music files which are similar in the mood and the genre to a query music.

An aspect of the present invention also provides a similar music searching method and a related apparatus allowing a reduction in a complexity of a feature extraction by using a compression zone for an extraction of music features.

An aspect of the present invention further provides a similar music searching method and a related apparatus allowing an improvement in a processing speed required for a search by classifying music files according to a mood and a genre in a compression zone.

An aspect of the present invention still further provides a similar music searching method and a related apparatus allowing a high reliability in a retrieval of a similar music by searching only music files which are identical in a mood and a genre to a query music.

An aspect of the present invention provides a method for searching a similar music, the method including: extracting first features from music files usable to classify a music by a mood and a genre; classifying the music files according to the mood and the genre using the extracted first features; extracting second features from the music files so as to retrieve a similarity; storing both mood information and genre information on the classified music files and the extracted second features in a database; receiving an input of information on a query music; detecting a mood and a genre of the query music; measuring a similarity between the query music and the music files that are identical in mood and genre to the query music by referring to the database; and retrieving the similar music with respect to the query music based on the measured similarity.

Another aspect of the invention provides an apparatus for searching for similar music, the apparatus including: a first feature extraction unit extracting first features from music files usable to classify a music by a mood and a genre; a mood/genre classification unit classifying the music files according to the mood and the genre using the extracted first features; a second feature extraction unit extracting second features from the music files usable to retrieve a similarity; a database storing both mood information and genre information on the classified music files and the extracted second features; a query music input unit receiving an input of information on a query music; a query music detection unit detecting a mood and a genre of the query music using the input information of the query music and finding the first and the second features of the query music for a similarity retrieval; and a similar music retrieval unit retrieving the similar music from the music files which are identical in mood and genre to the detected query music while referring to the database.

Another aspect of the present invention provides a method of searching for similar music, the method including: classifying music files according to mood and genre using extracted first features, which are features of the music files usable to classify music by a mood and a genre; storing both mood information and genre information on the classified music files and extracted second features which are usable to retrieve a similarity in a database; detecting a mood and a genre of an input query music; measuring a similarity between the query music and the music files that are identical in mood and genre to the query music by referring to the database; and retrieving the similar music with respect to the query music based on the measured similarity.

Other aspects of the present invention provide computer-readable storage media storing programs for implementing the aforementioned methods.

Additional and/or other aspects and advantages of the present invention will be set forth in part in the description which follows and, in part, will be obvious from the description, or may be learned by practice of the invention.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 illustrates an apparatus for searching a similar music according to an embodiment of the present invention.

FIG. 2 illustrates an example of classifying a music by a mood in a similar music searching apparatus according to an embodiment the present invention.

FIG. 3 illustrates a method for searching a similar music according to an embodiment of the present invention.

FIG. 4 illustrates an example of extracting timbre features in a similar music searching method according to an embodiment the present invention.

FIG. 5 illustrates an example of extracting tempo features in a similar music searching method according to an embodiment the present invention.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

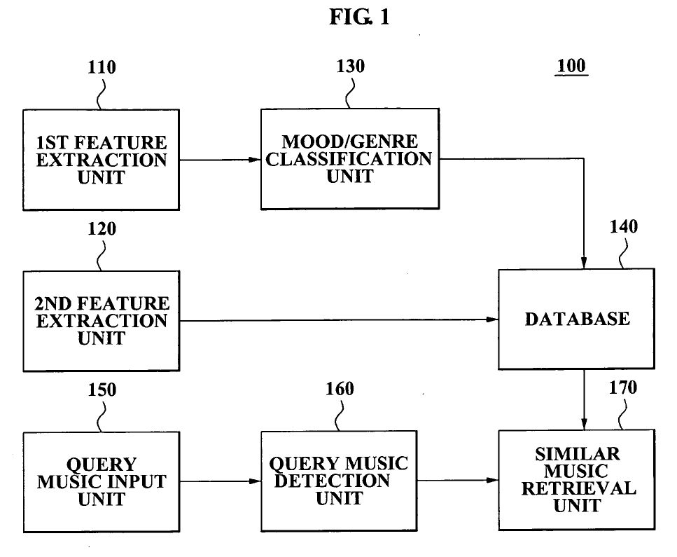

FIG. 1 illustrates an apparatus for searching a similar music according to an embodiment of the present invention.

Referring to FIG. 1, the similar music searching apparatus 100 includes a first feature extraction unit 110, a second feature extraction unit 120, a mood/genre classification unit 130, a database 140, a query music input unit 150, a query music detection unit 160, and a similar music retrieval unit 170.

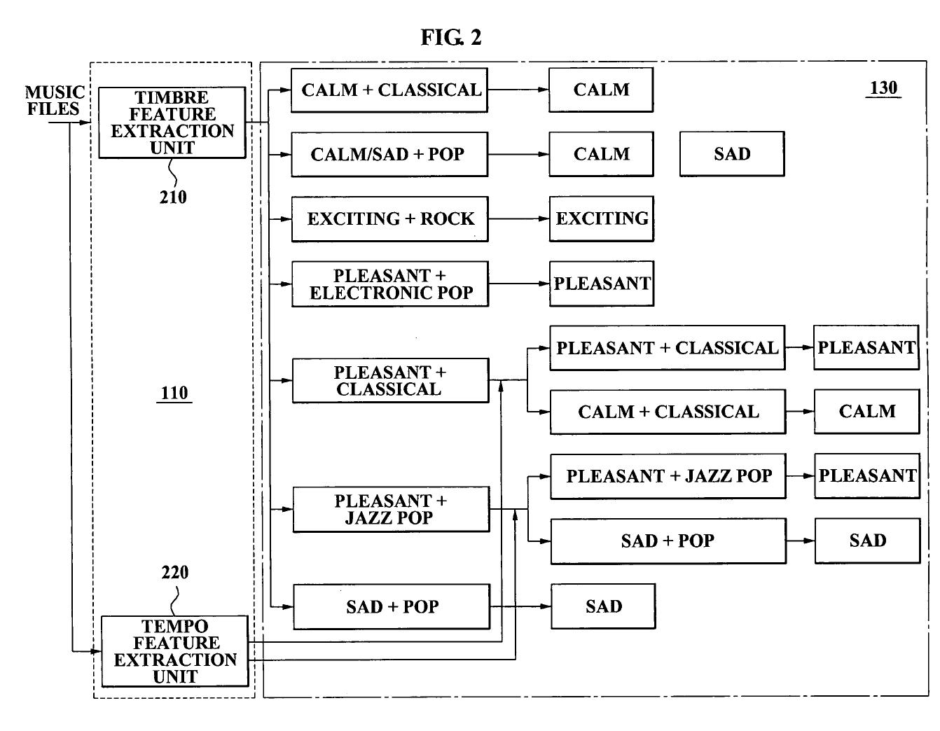

The first feature extraction unit 110 extracts first features from music files to classify music by a mood and a genre. As shown in FIG. 2, the first feature extraction unit 110 may include a timbre feature extraction unit 210 and a tempo feature extraction unit 220.

Referring to FIG. 2, the timbre feature extraction unit 210 obtains timbre features based on an MDCT (Modified Discrete Cosine Transformation) from a compression zone of the music files. Specifically, the timbre feature extraction unit 210 extracts MDCT coefficients by partially decoding the music files compressed in, for example, an MP3 (MPEG Audio Layer 3) format. Then the timbre feature extraction unit 210 selects proper MDCT coefficients among the extracted MDCT coefficients and extracts timbre features from the selected MDCT coefficients. The timbre extraction unit 210 may extract MDCT coefficients from various types of music file formats such as an AAC (Advanced Audio Coding) format as well as an MP3 format.

The tempo feature extraction unit 220 obtains MDCT-based tempo features from the compression zone of the music files. Specifically, the tempo feature extraction unit 220 extracts MDCT coefficients by partially decoding the music files compressed in the MP3 format or the MC format. Then the tempo extraction unit 220 selects proper MDCT coefficients among the extracted MDCT coefficients and extracts an MDCT-MS (MDCT Modulation Spectrum) from the selected MDCT coefficients by performing a DFT (Discrete Fourier Transformation). Also the tempo extraction unit 220 divides the extracted MDCT-MS into sub-bands and extracts an energy from the sub-bands in order to use the energy as tempo features of the music files.

As described above, the apparatus 100 of the present embodiment extracts timbre features and tempo features from the compression zone of the music files. Therefore, the present embodiment may improve processing speed in comparison with a conventional extraction in the decompression zone.

Referring to FIG. 1, the second feature extraction unit 120 obtains second features from the music files usable to retrieve the similarity. Specifically, the second feature extraction unit 120 extracts MDCT-based timbre features and MDCT-MS-based tempo features from the music files. Then the second feature extraction unit 120 computes a maximum, a mean, and a standard deviation of respective features extracted in a corresponding analysis zone and stores the maximum, the mean, and the standard deviation of respective features in the database 140.

The mood/genre classification unit 130 classifies the music files by the mood and the genre, depending on the extracted timbre features and the extracted tempo features.

As shown in FIG. 2, the mood/genre classification unit 130 may firstly classify the music files according to seven classes with four types of moods, e.g. a calm in classical, a calm/sad in pop, an exciting in rock, a pleasant in electronic pop, a pleasant in classical, a pleasant in jazz pop, and a sad in pop, depending on the timbre features extracted by the timbre feature extraction unit 210.

The mood/genre classification unit 130 may secondly classify the first classified music files, depending on the tempo features. For example, when the music files belong to the ‘pleasant+classical’ as the result of the first classifying, such music files may be separated into the ‘calm+classical’ and the ‘pleasant+classical’. Similarly, the first classified music files belonging to the ‘pleasant+jazz pop’ may be separated into the ‘sad+pop’ and the ‘pleasant+jazz pop’.

If the music files include a tag data representing a genre information; the mood/genre classification unit 130 may extract the tag data from the music files and then arrange the music files according to the genre by using the genre information of the extracted tag data.

The mood/genre classification unit 130 stores the mood information and the genre information of the classified music files in the database 140.

The database 140 collects, as a metadata, the mood information and the genre information of the classified music files and the extracted second feature information for a similarity retrieval. The second feature information includes the maximum, the average, and the standard deviation of features extracted as the MDCT-based timbre features and the MDCT-MS-based tempo features from the music files.

The query music input unit 150 receives input of query music information.

The query music detection unit 160 detects the mood and the genre of the query music by using the input of the query music information and finds features of the query music for the similarity retrieval.

The similar music retrieval unit 170 searches the similar music from the music files which are identical in the mood and the genre to the detected query music, referring to the database 140.

Additionally, the similar music retrieval unit 170 may further search the similar music to the query music by using the maximum, the average, and the standard deviation.

The similar music retrieval unit 170 may also compute Euclidean distances of the first and second features of the music files being identical in the mood and the genre to the query music, and may retrieve an N number of music the computed distances of which are smaller than a predetermined value as similar music.

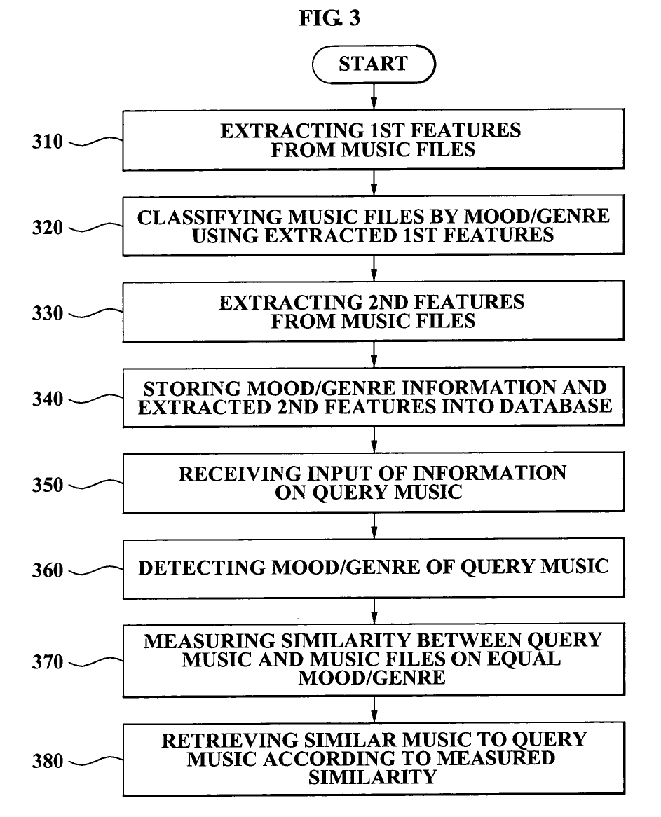

FIG. 3 is a flowchart illustrating a method for searching a similar music according to an embodiment of the present invention. This method is, for ease of explanation only, described in conjunction with the apparatus of FIG. 1.

In operation 310, the similar music searching apparatus extracts first features from music files to classify a music according to a mood and a genre.

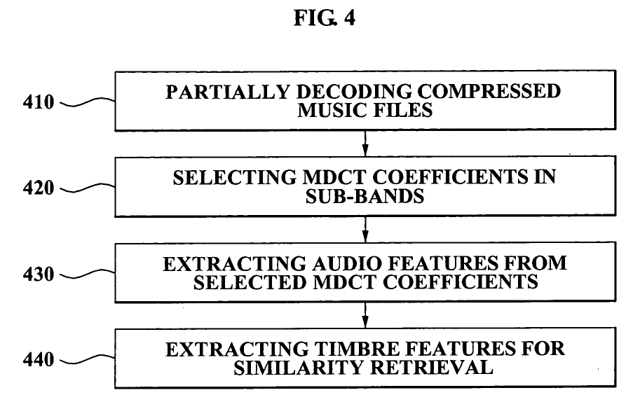

In operation 310, the apparatus may extract the MDCT-based timbre features, as the first features, from the compression zone of the music files. A process of extracting MDCT-based timbre features will be explained hereinafter referring to FIG. 4.

FIG. 4 is a flowchart illustrating an example of extracting timbre features in a similar music searching method according to an embodiment of the present invention.

Referring to FIG. 4, in operation 410, the similar music searching apparatus obtains, as an example, 576 pieces of MDCT coefficients Sᵢ(n) by partially decoding the music files compressed in a proper compression technique. Here, ‘n’ represents a frame index, and ‘i’ (0-575 in this example) represents a sub-band index of MDCT.

In operation 420, the apparatus selects some MDCT coefficients Sₖ(n) among the above example of 576 pieces of MDCT coefficients. Here, ‘Sₖ(n)’ represents the selected MDCT coefficients, and ‘k(<i)’ represents the selected MDCT sub-band index.

In operation 430, the apparatus extracts 25 pieces of timbre features from the selected respective MDCT coefficients. The extracted timbre features may include a spectral centroid, a bandwidth, a rolloff, a flux, a spectral a sub-band peak, a valley, an average, etc.

$$C ( n ) = \frac{{\sum }_{i = 0}^{k - 1} ( k + 1 ) {s}_{i} ( n )}{{\sum }_{i = 0}^{k - 1} {s}_{i} ( n )} \qquad [ Equation 1 ]$$

The above equation 1 is related to a centroid, which represents a highest beat rate.

$$B ( n ) = \sqrt{\frac{{\sum }_{i = 0}^{k - 1} {[ ⅈ + 1 - C ( n ) ]}^{2} \times {{S}_{i} ( n )}^{2}}{{\sum }_{i = 0}^{k - 1} {{S}_{i} ( n )}^{2}}} \qquad [ Equation 2 ]$$

The above equation 2 is related to a bandwidth, which represents a range of a beat rate.

$${\sum }_{i = 0}^{R ( n )} {s}_{i} ( n ) = 0.95 \cdot {\sum }_{i = 0}^{k - 1} {s}_{i} ( n ) \qquad [ Equation 3 ]$$

The above equation 3 is related to a rolloff.

$$F ( n ) = {\sum }_{i = 0}^{k - 1} {( {s}_{i} ( n ) - {s}_{i} ( n - 1 ) )}^{2} \qquad [ Equation 4 ]$$

The above equation 4 is related to a flux, which represents a variation of the beat rate according to a time.

$${B}_{peak} ( n ) = {max}_{0 \leq i \leq I - 1} [ \vert {s}_{i} ( n ) \vert ] \qquad [ Equation 5 ]$$

The above equation 5 is related to a sub-band peak.

$${B}_{valley} ( n ) = {min}_{0 \leq i \leq I - 1} [ \vert {s}_{i} ( n ) \vert ] \qquad [ Equation 6 ]$$

The above equation 6 is related to a valley.

$${B}_{average} ( n ) = \frac{1}{I} \cdot {\sum }_{i = 0}^{I - 1} \vert {s}_{i} ( n ) \vert \qquad [ Equation 7 ]$$

The above equation 7 is related to an average.

In operation 430, the apparatus extracts a flatness feature from the selected MDCT coefficients.

$$Ft ( n ) = 20 {log}_{10} ( \frac{{\sum }_{i = 0}^{k - 1} log ( {s}_{i} ( n ) )}{{\sum }_{i = 0}^{k - 1} {s}_{i} ( n )} ) \qquad [ Equation 8 ]$$

The above equation 8 is related to a flatness, which ascertains a clear and strong beat.

In operation 440, the apparatus extracts the timbre features for a similarity retrieval. That is, the apparatus may compute a maximum, a mean, and a standard deviation with regard to the above-described centroid, the bandwidth, the flux, and the flatness.

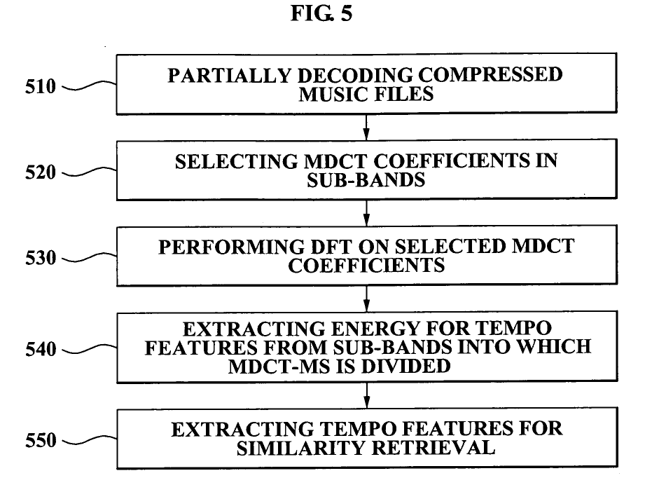

In FIG. 3, in operation 310, the apparatus may extract an MDCT-based tempo features from a compression zone of the music files. A process of extracting the MDCT-based tempo features will be explained hereinafter referring to FIG. 5.

FIG. 5 is a flowchart illustrating an example of extracting tempo features in a similar music searching method according to an embodiment of the present invention. This method is, for ease of explanation only, described in conjunction with the apparatus of FIG. 1.

Referring to FIG. 5, in operation 510, the similar music searching apparatus 100 obtains, as an example 576 pieces of MDCT coefficients Sᵢ(n) by partially decoding the music files compressed in a proper compression technique. Here, ‘n’ represents a frame index, and ‘i’ (0-575 in this example) represents a sub-band index of MDCT.

In a next operation 520, the apparatus selects MDCT coefficients Sₖ(n) which are powerful against noise environment among the above example of 576 pieces of MDCT coefficients. Here, ‘Sₖ(n)’ represents the selected MDCT coefficients, and ‘k(<i)’ represents the selected MDCT sub-band index.

In operation 530, the apparatus extracts an MDCT-MS by performing a DFT on the selected MDCT coefficients.

$$\begin{matrix}{X}_{k} ( n ) = {s}_{k} ( n ) & [ Equation 9 ] \\ {Y}_{k} ( q ) = {\sum }_{n = 0}^{N - 1} {X}_{k} ( n ) {ⅇ}^{- j \frac{2 π}{N} nq} & [ Equation 10 ]\end{matrix}$$

Here, ‘q’ represents a modulation frequency, and ‘N’ represents a DFT length on which a modulation resolution relies.

The MDCT-MS on which the DFT is performed by using a time shift may be expressed in a four-dimensional form having three variables as in the following equation 11.

$${Y}_{t , k} ( q ) = {\sum }_{n = 0}^{N - 1} {X}_{k} ( t + n ) {ⅇ}^{- j \frac{2 π}{N} nq} \qquad [ Equation 11 ]$$

Here, ‘t’ represents a time index, Specifically, a shift of the MDCT-MS in time.

In operation 540, the apparatus divides the MDCT-MS into an N number of sub-bands, and extracts energy from the sub-bands in order to use the energy as the MDCT-MS-based tempo features.

In operation 550, the apparatus obtains a centroid, a bandwidth, a flux, and a flatness based on the MDCT-MS from the extracted tempo features so as to retrieve a similarity. That is, in operation 550, the apparatus may extract, as second features for similarity retrieval, the centroid, the bandwidth, the flux, and the flatness according to the MDCT-MS-based tempo features.

As described above, the method for searching similar music may extract audio features for the similarity retrieval in a compression zone, thus allowing a reduction in complexity for feature extraction.

In FIG. 3, in operation 320, the apparatus classifies the music files by a mood and a genre, depending on extracted timbre features and extracted tempo features.

In operation 320, the apparatus classifies the music files by genre based on the extracted timbre features. When ambiguity in the results of genre classifying is higher than a predetermined standard, categories of the music files in the genre may be rearranged, for example, according to the extracted tempo features.

In operation 320, if the music files include a tag data representing genre information, the apparatus may extract the tag data from the music files and then arrange the music files according to the genre by using the genre information of the extracted tag data.

In operation 320, depending on the extracted timbre features, the apparatus may firstly classify the music files according to seven classes with four types of moods, e.g. a calm in classical, a calm/sad in pop, an exciting in rock, a pleasant in electronic pop, a pleasant in classical, a pleasant in jazz pop, and a sad in pop.

Additionally, depending on the extracted tempo features, the apparatus may secondly classify some of the music files first classified but falling within a highly ambiguous classification, e.g. pleasant+classical and pleasant+jazz pop. If the music files belong to the ‘pleasant+classical’ as the result of the first classifying, such music files may be rearranged into categories of the ‘calm+classical’ and the ‘pleasant+classical’ according to the tempo features. Similarly, the firstly classified music files belonging to the ‘pleasant+jazz pop’ may be rearranged into categories of the ‘sad+pop’ and the ‘pleasant+jazz pop’ according to the tempo features.

Furthermore, in operation 320, the apparatus may merge the categories of the rearranged music files into a K number of moods. That is, the apparatus may unite the first classifying results by the timbre features and the second classifying results by the tempo features and then may combine the first and second classifying results into four mood classes, exciting, pleasant, calm, and sad.

Also, in operation 320, the apparatus may classify the music files into subdivided categories using a GMM (Gaussian Mixture Model).

In operation 330, the apparatus extracts the second features from the music files to retrieve the similarity of music.

In operation 330, the apparatus may extract the second features by employing the above-described operations 440 and 550 of extracting the first features. That is, the apparatus may compute the maximum, the mean, and the standard deviation of the timbre or tempo features extracted from the compression zone of the music files, and then may obtain the second features by using them.

As described above, since the similar music searching method according to an embodiment of the present invention extracts music features for similar music searching from the compression zone, the present embodiment may improve the entire processing speed for the similar music searching.

In operation 340, the apparatus stores, as a metadata, both mood information and genre information of the classified music files and the extracted second feature information in a database.

In operation 350, the apparatus receives input of information on a query music for searching similar music. If the query music is stored in the database, a title of the stored query music as information on the query music may be input.

In operation 360, the apparatus detects the mood and the genre of the inputted query music. If mood information and genre information on the inputted query music is stored in the database, the apparatus may extract the mood information and the genre information from the database.

In operation 370, by referring to the database, the apparatus measures the similarity between the query music and the music files being identical in the mood the genre to the query music. That is, in operation 370, the apparatus may compute Euclidean distances with regard to the first and second features of the music files being identical in the mood and the genre to the query music.

In operation 380, the apparatus retrieves similar music to the query music according to the measured similarity. That is, in operation 380, the apparatus may retrieve an N number of music the computed distances of which are smaller than a predetermined value as similar music.

As described above, a method according to an embodiment of the present invention may enhance the reliability of searching results since the method searches similar music only within similar mood and genre by using the classifying results according to mood and genre. Moreover, the method may improve a searching time since there is no need for searching all music.

Embodiments of the present invention include a program instruction capable of being executed via various computer units and may be recorded in a computer readable recording medium. The computer readable medium may include a program instruction, a data file, and a data structure, separately or cooperatively. The program instructions and the media may be those specially designed and constructed for the purposes of the present invention, or they may be of the kind well known and available to those skilled in the art of computer software arts. Examples of the computer readable media include magnetic media (e.g., hard disks, floppy disks, and magnetic tapes), optical media (e.g., CD-ROMs or DVD), magneto-optical media (e.g., optical disks), and hardware devices (e.g., ROMs, RAMs, or flash memories, etc.) that are specially configured to store and perform program instructions. The media may also be transmission media such as optical or metallic lines, wave guides, etc. including a carrier wave transmitting signals specifying the program instructions, data structures, etc. Examples of the program instructions include both machine code, such as produced by a compiler, and files containing high-level languages codes that may be executed by the computer using an interpreter. The hardware elements above may be configured to act as one or more software modules for implementing the operations of this invention.

According to the above-described embodiments of the present invention, provided are a similar music searching method with more reliable searching results and a related apparatus executing the method, which can search music files only within similar mood and genre to query music by using auto classifying results of the mood and the genre.

According to the above-described embodiments of the present invention, provided are a similar music searching method and a related apparatus, which can extract music features for similar music retrieval from a compression zone and thereby can improve an entire processing speed required for searching.

According to the above-described embodiments of the present invention, provided are a similar music searching method and a related apparatus, which can reduce a complexity of a feature extraction by using the compression zone during an extraction of audio features for similar music searching.

According to the above-described embodiments of the present invention, provided are a similar music searching method and a related apparatus, which do not require a search of all music and thus improve searching time.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A method of searching for similar music, the method comprising:
extracting first features from music files usable to classify a music by a mood and a genre;
classifying the music files according to the mood and the genre using the extracted first features;
extracting second features from the music files so as to retrieve a similarity;
storing both mood information and genre information on the classified music files and the extracted second features in a database;
receiving an input of information on a query music;
detecting a mood and a genre of the query music;
measuring a similarity between the query music and the music files that are identical in mood and genre to the query music by referring to the database; and
retrieving the similar music with respect to the query music based on the measured similarity.

2. The method of claim 1, wherein the extracting of the first features includes:
extracting Modified Discrete Cosine Transformation (MDCT) coefficients by partially decoding the music files;
selecting a predetermined number of sub-band MDCT coefficients among the extracted MDCT coefficients; and
extracting a spectral centroid, a bandwidth, a rolloff, a flux, and a flatness, as timbre features, from the selected MDCT coefficients.

3. The method of claim 2, wherein the extracting of the second features includes computing a maximum, a mean, and a standard deviation of the extracted timbre features.

4. The method of claim 1, wherein the extracting of the first features includes:
extracting MDCT coefficients by partially decoding the music files;
selecting a predetermined number of sub-band MDCT coefficients among the extracted MDCT coefficients;
extracting an MDCT Modulation Spectrum (MDCT-MS) by performing a discrete Fourier transform (DFT) on the selected MDCT coefficients; and
dividing the MDCT-MS into an N number of sub-bands and then extracting an energy from the divided sub-bands, the energy usable as tempo features based on the MDCT-MS.

5. The method of claim 4, wherein the extracting of the second features includes extracting a centroid, a bandwidth, a flux, and a flatness, as the second features for the retrieving, according to the MDCT-MS-based tempo features.

6. The method of claim 1, wherein the measuring a similarity includes computing Euclidean distances of the features of the music files that are identical in the mood and the genre to the query music.

7. The method of claim 6, wherein the retrieving the similar music includes retrieving an N number of the music files, as the similar music, the computed Euclidean distances of which are smaller than a predetermined value.

8. A computer-readable storage medium storing a program for implementing the method of claim 1.

9. An apparatus for searching for similar music, the apparatus comprising:
a first feature extraction unit extracting first features from music files usable to classify a music by a mood and a genre;
a mood/genre classification unit classifying the music files according to the mood and the genre using the extracted first features;
a second feature extraction unit extracting second features from the music files usable to retrieve a similarity;
a database storing both mood information and genre information on the classified music files and the extracted second features;
a query music input unit receiving an input of information on a query music;
a query music detection unit detecting a mood and a genre of the query music using the input information of the query music and finding the first and the second features of the query music for a similarity retrieval; and
a similar music retrieval unit retrieving the similar music from the music files which are identical in mood and genre to the detected query music while referring to the database.

10. The apparatus of claim 9, wherein the second feature extraction unit extracts MDCT-based timbre features and MDCT-MS-based tempo features from the music files, and computes a maximum, a mean, and a standard deviation of the respective features extracted in a corresponding analysis zone, and wherein the database stores the computed maximum, the computed mean, and the computed standard deviation as a metadata.

11. The apparatus of claim 10, wherein the retrieval unit searches similar music to the query music using the maximum, the average, and the standard deviation.

12. The apparatus of claim 11, wherein the retrieval unit computes Euclidean distances of features of the music files that are identical in the mood and the genre to the query music, and retrieves an N number of music the computed distances of which are smaller than a predetermined value as the similar music.

13. The apparatus of claim 9, wherein the music files include a tag data representing the genre information, and wherein the mood/genre classification unit extracts the tag data from the music files and then arranges the music files according to a genre using the genre information of the extracted tag data.

14. The apparatus of claim 9, wherein the music files include moving picture experts group audio layer-3 (MP3) files or advanced audio coding (ACC) files.

15. The apparatus of claim 9, wherein the mood information and the genre information of the classified music files and the extracted second feature information are stored as metadata.

16. The apparatus of claim 9, wherein the mood/genre classification unit classifies the music files by genre based on extracted timbre features and, when ambiguity in the results of genre classifying in a genre is greater than a threshold, categories of the music files in the genre are rearranged.

17. The apparatus of claim 16, wherein the mood/genre classification unit merges at least some of the categories of the rearranged music files into a number of moods.

18. A method of searching for similar music, the method comprising:
classifying music files according to mood and genre using extracted first features, which are features of the music files usable to classify music by a mood and a genre;
storing both mood information and genre information on the classified music files and extracted second features which are usable to retrieve a similarity in a database;
detecting a mood and a genre of an input query music;
measuring a similarity between the query music and the music files that are identical in mood and genre to the query music by referring to the database; and
retrieving the similar music with respect to the query music based on the measured similarity.

19. A computer-readable storage medium storing a program for implementing the method of claim 18.
